(19) United States
(12) Patent Application Publication
(10) Pub. No.: US 2016/0328009 A1
(43) Pub. Date: Nov. 10, 2016

(54) COMPUTING DEVICE AND METHOD FOR DISPLAYING SLEEPING INTERFACE AND WAKING-UP INTERFACE

(71) Applicants: Fu Tai Hua Industry (Shenzhen) Co., Ltd., Shenzhen (CN); HON HAI PRECISION INDUSTRY CO., LTD., New Taipei (TW)

(72) Inventors: HUI-GANG HE, Shenzhen (CN); CHIH-SAN CHIANG, New Taipei (TW); ZHAO-PING ZHANG, Shenzhen (CN); JIN-QI LU, Shenzhen (CN)

(21) Appl. No.: 14/734,831

(22) Filed: Jun. 9, 2015

(30) Foreign Application Priority Data
May 7, 2015 (CN) 201510228594.6

(51) Int. Cl. G06F 1/32

(52) U.S. Cl. CPC G06F 1/3296; G06F 1/3228

(57) ABSTRACT

In a sleeping interface rendering method, the computing device is currently in a running status is recognized. A request is received to cause the computing device to enter a sleep mode. Currently running data of the computing device is obtained. Time required to store the obtained currently running date is calculated, the obtained data is storing simultaneity. A minification pace of the predefined picture is determined according to the calculated time in the process when the computing device enters a sleep mode. Lastly, a minifying process of the predefined picture is displayed according to the determined minification pace.

### CROSS-REFERENCE TO RELATED APPLICATIONS

This application claims priority to Chinese Patent Application No. 201510228594.6 filed on May 7, 2015, the contents of which are incorporated by reference herein.

### FIELD

The subject matter herein generally relates to sleep management of computing devices, and more specifically relates to a computing device and a method for displaying sleeping interface and waking-up interface.

### BACKGROUND

In order to reduce energy consumption of computing devices, the computing device can be in a sleep mode except when in a turned-on mode or a shutdown mode.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of a hardware environment for executing a sleeping interface and waking-up interface display system.

FIG. 2 is a block diagram of one embodiment of function modules of the sleeping interface and waking-up interface displaying system in FIG. 1.

FIG. 3 is a flowchart of one embodiment of a method for displaying a sleeping interface.

FIG. 4 is a flowchart of one embodiment of a method for displaying a waking-up interface.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

Furthermore, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device. The term “comprising,” when utilized, means “including, but not necessarily limited to”; it specifically indicates open-ended inclusion or membership in the so-described combination, group, series and the like.

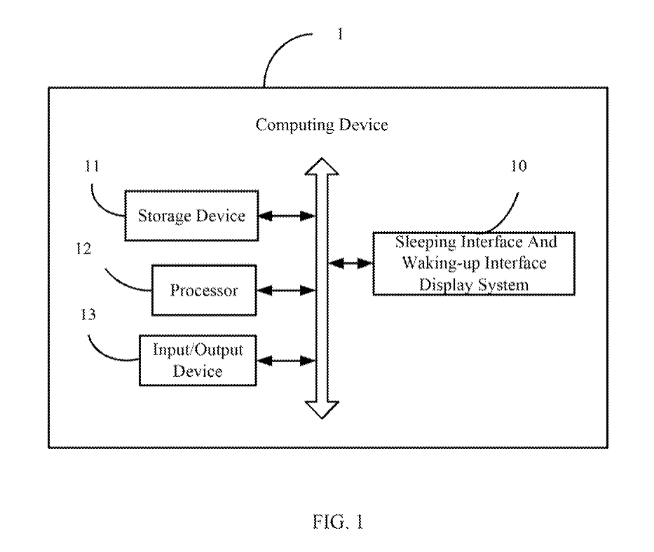

FIG. 1 is a block diagram of one embodiment of a hardware environment for executing a sleeping interface and waking-up interface display system. The sleeping interface and waking-up interface display system 10 (hereinafter “display system 10”) is installed and runs in an apparatus, for example a computing device 1. In at least the one embodiment as shown in FIG. 1, the computing device 1 includes, but is not limited to, a storage device 11, at least one processor 12, and an input/output device 13. The computing device 1 can be a tablet computer, a notebook computer, a smart phone, a personal digital assistant (PDA), or other suitable computing device. FIG. 1 illustrates only one example of the computing device; others can include more or fewer components than illustrated, or have a different configuration of the various components in other embodiments.

The display system 10 can display a sleeping interface when the computing device 1 enters the sleep mode, and display a waking-up interface when the computing device 1 enters the waking-up mode. A user of the computing device 1 can see the sleeping process via the displayed sleeping interface, and see the waking up process of the computing device 1 via the displayed waking-up interface.

In at least one embodiment, the storage device 11 can include various types of non-transitory computer-readable storage mediums. For example, the storage device 11 can be an internal storage system, such as a flash memory, a random access memory (RAM) for temporary storage of information, and/or a read-only memory (ROM) for permanent storage of information. The storage device 11 can also be an external storage system, such as a hard disk, a storage card, or a data storage medium. The at least one processor 12 can be a central processing unit (CPU), a microprocessor, or other data processor chip that performs functions of the display system 10 in the computing device 1. The input/output device 13 can be used by a user to input commands and display information. In the embodiment, the input/output device 13 is a touch screen. In other embodiments, the input/output device 13 can include an input device such as a mouse, a keyboard, or a touch panel, and an out device such as a display screen.

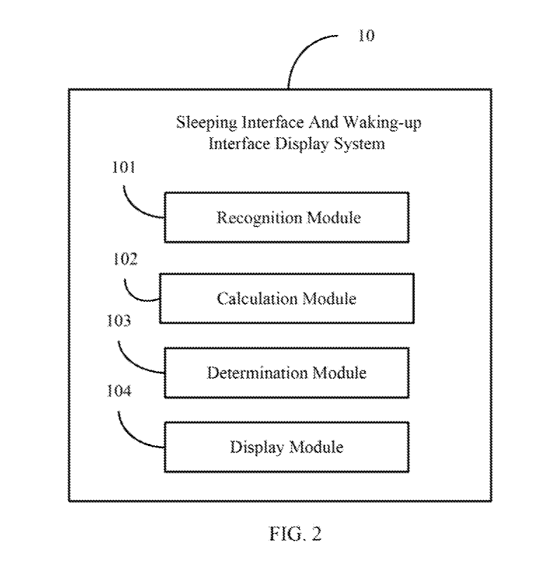

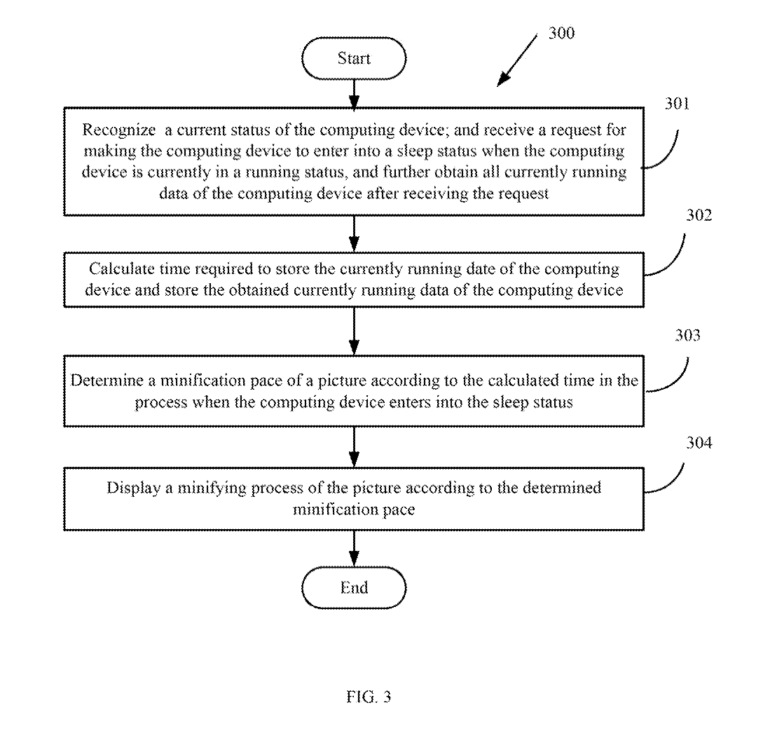

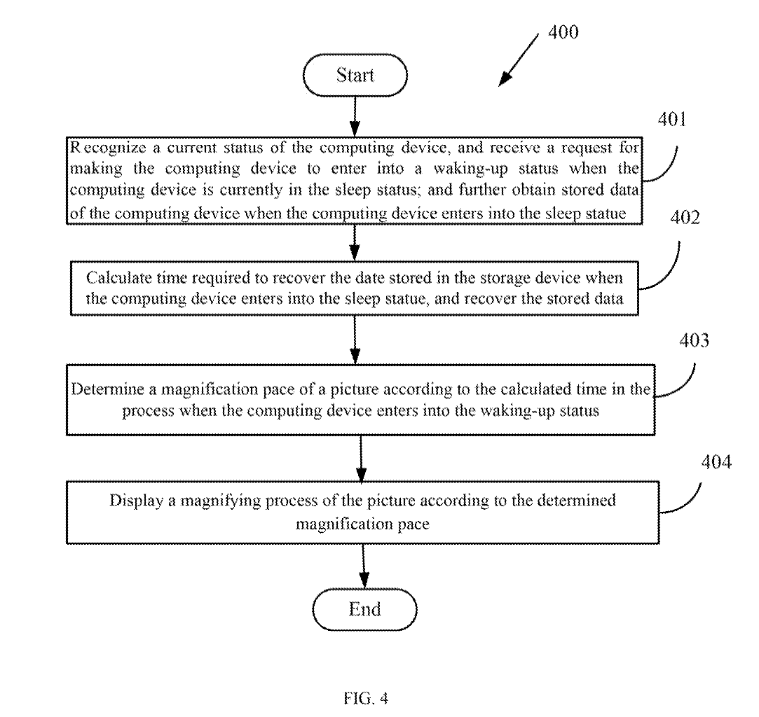

FIG. 2 is a block diagram of one embodiment of the function modules of the display system 10. In at least one embodiment, the display system 10 can include a recognition module 101, a calculation module 102, a determination module 103, and a display module 104. The function modules 101-104 can include computerized codes in the form of one or more programs, which are stored in the storage device 11. The at least one processor 12 executes the computerized codes to provide functions of the function modules 101-104. A detailed description of the functions of the modules 101-104 is given below in reference to FIGS. 3 and 4.

FIG. 3 illustrates a flowchart of one embodiment of a method for displaying a sleeping interface. The example method 300 is provided by way of example, as there are a variety of ways to carry out the method. The method 300 described below can be carried out using the configurations illustrated in FIGS. 1-3, for example, and various elements of these figures are referenced in explaining example method 300. Each block shown in FIG. 3 represents one or more processes, methods or subroutines, carried out in the exemplary method 300. Furthermore, the illustrated order of blocks is by example only and the order of the blocks can change according to the present disclosure. The exemplary method 300 can begin at block 301. Depending on the embodiment, additional steps can be added, others removed, and the ordering of the steps can be changed.

At block 301, the recognition module recognizes a current status of the computing device, and receives a request to cause the computing device enter a sleep mode when the computing device is currently in a running status, and further obtains all currently running data of the computing device after receiving the request.

In the embodiment, a user can operate a particular touch button, icon or menu which is displayed on the input/output device 13 to input the request to cause the computing device 1 enter a sleep mode. In other embodiments, a user can operate a particular press key (not shown in FIGS) of the computing device 1 to input the request. In the embodiment, the currently running data includes application programs which are currently running, pictures which are being viewed, webpage which are being browsed, files which are open, or the like.

At block 302, the calculation module calculates time required to store the currently running date of the computing device obtained by the recognition module and stores the obtained currently running data of the computing device.

In the embodiment, the currently running date of the computing device 1 can be stored in the storage device 11 in the time interval calculated by the calculation module 102.

At block 303, the determination module determines a minification pace of a predefined picture according to the calculated time in the process when the computing device enters the sleep mode.

In the embodiment, the minification pace of the predefined picture is a minification proportion in each time interval, for example, minifying 20% each second. The time when the predefined picture is minified from a biggest display area to a smallest display area equals the time interval calculated by the calculation module 102.

In the embodiment, the storage device 11 stores the predefined picture to be displayed in the process when the computing device 1 enters the sleep mode, and a predefined display mode of the predefined picture. The determination module 103 will gradually minify the predefined picture from the biggest display area to the smallest display area in the time associated with the whole process of entering the sleep mode. That is, the predefined picture has the biggest display area when the computing device 1 just starts to enter the sleep mode; and the predefined picture has the smallest display area until disappearing when the computing device 1 enters the sleep mode.

At block 304, the display module displays the minifying process of the predefined picture according to the minification pace determined by the determination module.

In one embodiment, the predefined display mode of the predefined picture is a rectangular shape. The predefined picture is minified gradually according to the minification pace towards to a center point, a border line or one vertex of the rectangular in the calculated time calculated by the calculation module 102. In other embodiment, the predefined display mode of the predefined picture is a five-pointed star shape. The predefined picture is minified gradually according to the determined minification pace towards to a center point or one vertex of the five-pointed star in the calculated time interval calculated by the calculation module 102.

FIG. 4 illustrates a flowchart of one embodiment of a method for displaying a waking-up interface. The example method 400 is provided by way of example, as there are a variety of ways to carry out the method. The method 400 described below can be carried out using the configurations illustrated in FIGS. 1, 2 and 4, for example, and various elements of these figures are referenced in explaining example method 400. Each block shown in FIG. 4 represents one or more processes, methods or subroutines, carried out in the exemplary method 400. Furthermore, the illustrated order of blocks is by example only and the order of the blocks can change according to the present disclosure. The exemplary method 400 can begin at block 401. Depending on the embodiment, additional steps can be added, others removed, and the ordering of the steps can be changed.

At block 401, the recognition module recognizes a current status of the computing device, and receives a request to cause the computing device enter a waking-up status when the computing device is currently in the sleep mode; and further obtains stored data of the computing device when the computing device enters the sleep mode.

In the embodiment, a user can operate a particular touch button or press key, for example, the source press key (not shown in FIGS) of the computing device 1, to input the request to cause the computing device 1 enter a waking-up status. The stored data is currently running data when the computing device 1 enters the sleep mode.

At block 402, the calculation module calculates time required to recover the stored date obtained by the recognition module, and recovers the stored data.

In the embodiment, the calculation module 102 recovers the stored data in the time interval calculated by the calculation module 102.

At block 403, the determination module determines a magnification pace of a predefined picture according to the calculated time in the process when the computing device enters the waking-up status.

In the embodiment, the magnification pace of the predefined picture is a magnification proportion in each time interval, for example, magnifying 20% each second. The time when the predefined picture is magnified from a smallest display area to a biggest display area equals the time calculated by the calculation module 102.

In the embodiment, the storage device 11 stores the predefined picture to be displayed in the process when the computing device 1 enters the waking-up status, and a predefined display mode of the predefined picture. The determination module 103 will gradually magnify the predefined picture from the smallest display area to the biggest display area in the time associated with the whole process of entering the waking-up status. That is, the predefined picture has the smallest display area when the computing device 1 just starts to enter the waking-up status and the predefined picture has the biggest display area when the computing device 1 enters the waken-up status.

At block 404, the display module displays a magnifying process of the predefined picture according to the magnification pace determined by the determination module.

In one embodiment, the predefined display mode of the predefined picture is a rectangular shape. The predefined picture is magnified gradually according to the magnification pace from a center point, a border line or one vertex of the rectangular in the time interval calculated by the calculation module 102. In other embodiments, the predefined display mode of the predefined picture is a five-pointed star shape. The predefined picture is magnified gradually according to the determined magnification pace from a center point or one vertex of the five-pointed star in the time interval calculated by the calculation module 102.

In other embodiments, the predefined display mode of the predefined picture is a regular polygon shape, for example, a triangle, a rhombus, a hexagon, or the like. The predefined picture is magnified gradually according to the determined magnification pace from a center point of the regular polygon in the time interval calculated by the calculation module 102.

The embodiments shown and described above are only examples. Many details are often found in the art and many such details are therefore neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A method for rendering a sleeping interface executable by at least one processor of a computing device, the computing device storing a predefined picture to be displayed in a process when the computing device enters a sleep mode, and a display mode of the predefined picture, the method comprising:
recognizing that the computing device is currently in a running status;
receiving a request to cause the computing device to enter a sleep mode when the computing device is currently in the running status;
obtaining currently running data of the computing device;
calculating time required to store the obtained currently running date and storing the obtained currently running data;
determining a minification pace of the predefined picture according to the calculated time in the process when the computing device enters a sleep mode; and
displaying a minifying process of the predefined picture according to the determined minification pace.

2. The method according to claim 1, wherein the minification pace of the predefined picture is a minification proportion in each time interval, the time when the predefined picture is minified from a biggest display area to a smallest display area equals the calculated time.

3. The method according to claim 2, wherein the predefined picture has the biggest display area when the computing device just starts to enter the sleep mode; and the predefined picture has the smallest display area when the computing device enters the sleep mode.

4. The method according to claim 3, wherein the display mode of the predefined picture is a rectangular shape; and the predefined picture is minified gradually according to the determined minification pace towards to a center point, a border line or one vertex of the rectangular in the calculated time.

5. The method according to claim 3, wherein the display mode of the predefined picture is a five-pointed star shape; and the predefined picture is minified gradually according to the determined minification pace towards to a center point or one vertex of the five-pointed star in the calculated time.

6. A method for rendering a waking-up interface executable by at least one processor of a computing device, the computing device storing a predefined picture to be displayed in a process when the computing device enters a waking-up status, and a display mode of the predefined picture, the method comprising:
recognizing that the computing device is currently in a sleep mode;
receiving a request to cause the computing device to enter a waking-up status when the computing device is currently in the sleep mode;
obtaining currently running data of the computing device, wherein the currently running date is stored when the computing device enters the sleep statue;
calculating time required to recover the stored date and recovering the stored data;
determining a magnification pace of the predefined picture according to the calculated time in the process when the computing device enters a waking-up status; and
displaying a magnifying process of the predefined picture according to the determined magnification pace.

7. The method according to claim 6, wherein a magnification pace of the predefined picture is a magnification proportion in each time interval, the time when the predefined picture is minified from a smallest display area to a biggest display area equals the calculated time.

8. The method according to claim 7, wherein the predefined picture has the smallest display area when the computing device just starts to enter the waking-up status; and
the predefined picture has the biggest display area when the computing device enters the waked-up status.

9. The method according to claim 8, wherein the display mode of the predefined picture is a rectangular shape; and the predefined picture is magnified gradually towards to a center point, a border line or one vertex of the rectangular in the calculated time.

10. The method according to claim 8, wherein the display mode of the predefined picture is a five-pointed star shape; and the predefined picture is magnified gradually towards to a center point or one vertex of the five-pointed star in the calculated time.

11. A computing device, comprising:
a processor; and
a storage device that stores a picture to be displayed in a process when the computing device enters a sleep or waking-up status, and one or more programs which, when executed by the at least one processor, cause the processor to:
recognize a current status of the computing device;
obtain data associated with the current status;
receive a request to cause the computing device from the current status to enter another status;
calculate time required to process the data associated with the current status;
process the data associated with the current status;
determine a magnification pace or a minification pace of the picture according to the calculated time in the process when the computing device enters from the current status into another status; and
display a magnifying process of the picture according to the determined magnification pace or a minifying process of the picture according to the determined minification pace.

12. The computing device according to claim 11, wherein the current status of the computing device comprising a sleep mode and a running status; when the computing device is currently in the running status, the data associated with the current status is currently running data of the computing device; when the computing device is currently in the sleep mode, the data associated with the current status is stored currently running data when the computing device enters the sleep statue.

13. The computing device according to claim 12, wherein when a request is received to cause the computing device from the running status to enter the sleep mode, the processor is further caused to:
calculate time required to store the currently running date;
store the currently running data into the storage device;
determine a minification pace of the picture according to the calculated time in the process when the computing device enters the sleep mode; and
display the minifying process of the picture according to the determined minification pace in a predefined display mode.

14. The computing device according to claim 13, wherein a minification pace of the picture is a minification proportion in each time interval, the time when the picture is minified from a biggest display area to a smallest display area equals the calculated time.

15. The computing device according to claim 14, wherein the display mode of the picture is a rectangular shape; and the picture is minified gradually towards to a center point, a border line or one vertex of the rectangular in the calculated time.

16. The computing device according to claim 14, wherein the display mode of the picture is a five-pointed star shape; and the picture is minified gradually towards to a center point or one vertex of the five-pointed star in the calculated time.

17. The computing device according to claim 12, wherein when a request is received to cause the computing device from the sleep mode to enter the waking-up status, the processor is further caused to:
obtain stored currently running data of the computing device;
calculate time required to recover the stored date;
recover the stored data;
determine a magnification pace of the picture according to the calculated time in the process when the computing device enters a waking-up status; and
display a magnifying process of the picture according to the determined magnification pace in a predefined display mode.

18. The computing device according to claim 17, wherein the display mode of the picture is a rectangular shape; and the predefined picture is magnified gradually towards to a center point, a border line or one vertex of the rectangular in the calculated time.

19. The computing device according to claim 17, wherein the display mode of the picture is a five-pointed star shape; and the predefined picture is magnified gradually towards to a center point or one vertex of the five-pointed star in the calculated time.
